(19) United States
(12) Patent Application Publication
(10) Pub. No.: US 2009/0310686 A1
(43) Pub. Date: Dec. 17, 2009

(54) DISTRIBUTED DECODING DEVICE OF SEQUENTIAL PARALLEL PROCESSING SCHEME AND METHOD FOR THE SAME

(75) Inventor: Chang-Seo KEE, Goyang-si (KR)

Correspondence Address: GREENBLUM & BERNSTEIN, P.L.C., 1950 ROLAND CLARKE PLACE, RESTON, VA, 20191, US

(73) Assignees: Do-Hyoung Kim, Gyeonggi-do (KR); DVICO Inc., Gyeonggi-do (KR)

(21) Appl. No.: 12/485,347

(22) Filed: Jun. 16, 2009

(30) Foreign Application Priority Data
Jun. 17, 2008 (KR) 2008-0056976

(51) Int. Cl. H04N 7/26

(52) U.S. Cl. 375/240.25; 375/E07.027; 370/474

(57) ABSTRACT

The present invention relates to distributed decoding of sequential parallel processing scheme. More particularly, the present invention relates to distributed decoding of sequential parallel processing scheme, in which a plurality of slices of video stream are separated into headers and bodies, followed by sequentially parsing the headers and parallel decoding the bodies. According to the present invention, there is an advantageous effect in that time for decoding slice bodies is reduced and reproduction of high resolution video is smoothly processed.

### BACKGROUND OF THE INVENTION

1. Field of the Invention

The present invention relates to a distributed decoding of sequential parallel processing scheme. More particularly, the present invention relates to a distributed decoding of sequential parallel processing scheme, in which a plurality of slices contained in video stream are separated into headers and bodies, followed by sequentially parsing the headers and parallel decoding the bodies.

2. Description of the Related Art

Conventionally, a processor decodes video stream by applying a sequential decoding scheme. In the sequential decoding scheme, a picture is created by sequentially decoding a plurality of slices contained in the video stream. The processor continuously outputs pictures to configure a video screen.

A slice is configured with a header and bodies, in which the slice header contains information for video compression and location of video data in a picture, and the slice bodies are compressed video data. In the sequential decoding scheme, the slice is processed by parsing the headers and then sequentially decoding the bodies with referring to information in the parsed header.

If video compression rate is high, time for decoding slice bodies varies depending on the performance of a processor. Therefore, a high performance processor is required to reduce the body decoding time.

Although a single-core processor with an enhanced operating frequency reduces time for decoding the slice bodies by increasing the amount of operations per hour, since a task for decoding the slice bodies requires a large amount of operations, the operation speed of the single-core processor is insufficient for the decoding task. That is, the task for decoding the slice bodies requires distributed processing, and the application of a multi-core processor capable of processing of the operations in a distributed manner is required.

### SUMMARY OF THE INVENTION

An object of the present invention is to provide distributed decoding of sequential parallel processing scheme, for reducing video decoding time by efficiently using multiple cores, in which decoding can be performed in parallel and distributed manner, thereby smoothly displaying even a high resolution video.

According to an aspect of the present invention for achieving the object, there is provided a distributed decoding device, which comprises a memory for buffering video stream including a plurality of slices; a detection unit for separating the plurality of slices into slice headers and slice bodies and for detecting a beginning slice of a picture based on information in the slice headers; a header-parsing unit for sequentially parsing the slice headers beginning from the beginning slice so as to obtain header information for the picture; a parallel-processing unit for receiving a plurality of slice bodies associated with the parsed slice headers, and for dispatching a plurality of tasks for decoding the slice bodies to multiple cores so that the multiple cores process the decoding tasks in parallel scheme; and a picture-configuration unit for receiving header information from the header-parsing unit and receiving a plurality of decoded data from the parallel-processing unit wherein each of the decoded data corresponds to each of slice bodies, and for arranging the plurality of decoded data to picture blocks so as to configure the picture with referring to the header information.

According to another aspect of the present invention, there is provided a distributed decoding method, which comprises buffering video stream including a plurality of slices; separating the plurality of slices into slice headers and slice bodies; detecting a beginning slice of a picture based on information in the slice headers; sequentially parsing the slice headers beginning from the beginning slice so as to obtain header information for the picture; dispatching to multiple cores a plurality of tasks for decoding the slice bodies which are associated with the parsed slice headers; parallel processing the plurality of decoding tasks for the slice bodies in the multiple cores; and arranging, with referring to the header information, a plurality of decoded data to picture blocks so as to configure the picture.

### BRIEF DESCRIPTION OF THE DRAWINGS

FIG. 1 is a block diagram showing a distributed decoding device of sequential parallel processing scheme according to the present invention;

FIG. 2 is a flowchart illustrating a distributed decoding method of sequential parallel processing scheme according to the present invention; and

FIG. 3 is a view showing an example of decoding a plurality of slices according to the present invention.

### DESCRIPTION OF THE PREFERRED EMBODIMENT

Hereinafter, preferred embodiments of the present invention will be described in detail with reference to the accompanying drawings.

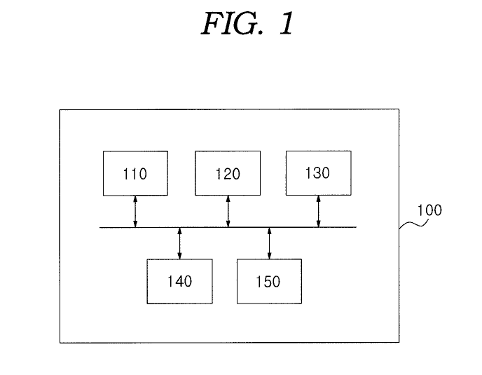

FIG. 1 is a block diagram showing a distributed decoding device of sequential parallel processing scheme according to the present invention. Video stream processed by an H.264 codec does not have a picture layer unlike MPEG and contains a plurality of slices configured to have slice headers and slice bodies. Since the H.264 codec does not have a picture layer, a distributed decoding device 100 should create a frame for configuring a picture by decoding the slice headers containing information that will act as a picture layer.

Since the constitutional elements (e.g., slices) of the video stream processed by the H.264 codec are related to one another, it is generally considered that they should be processed sequentially. Based on the general concept like this, although even a personal computer (PC) mounted with a multi-core processor sequentially processes H.264 data in decoding the data and thus a large amount of resources are wasted, it is unavoidably accepted. Therefore, decoding of new scheme is proposed in the present invention.

In the H.264 codec, slice headers are divided into a header that contains information on creating a frame for configuring a picture and a header that is not related to creating the picture frame. For this reason, slice headers should be sequentially processed in the H.264 codec. On the other hand, the slice bodies of the H.264 codec are compressed by the same algorithm and are mutually independent. That is, the distributed decoding device 100 can dispatch a plurality of slice bodies to multiple cores so as to process the slice bodies in parallel. A multi-core processor is employed in the distributed decoding device 100 for parallel processing of slice bodies.

On the video stream containing a plurality of slices, the distributed decoding device 100 processes slice headers to which a sequential processing method is applied, and slice bodies to which parallel processing method is applied. The configuration of the distributed decoding device 100 for processing the plurality of slices will be described.

The multi-core processor used in the distributed decoding device 100 comprises a plurality of cores and can operate as a plurality of devices by an execution code stored in program memory. The distributed decoding device 100 buffers video stream inputted online or offline in a memory 110.

The memory 110 buffers the video stream containing a plurality of slices. The slice is configured to have slice headers that contain a compression method of video data and information on the location of the video data in a picture, and slice bodies, i.e., compressed video data. The slice headers are divided into a header that contains information on creating a frame for configuring a picture and a header that is not related to creating the picture frame.

A detection unit 120 separates the plurality of slices buffered in the memory 110 into headers and bodies. The detection unit 120 detects the beginning slice of a picture containing information on creating a frame for configuring the picture by sequentially parsing the separated slice headers. The beginning slice of a picture contains slice headers having information on creating a frame for configuring the picture.

A header-parsing unit 130 sequentially parses the plurality of slice headers starting from the beginning slice detected by the detection unit 120. The header-parsing unit 130 obtains information to be used for decoding the slice bodies by sequentially parsing the plurality of slice headers with reference to the information on the frame for configuring the picture parsed from the header of the beginning slice. The header-parsing unit 130 transfers the information to be used for decoding the slice bodies to a parallel-processing unit 140 so that the plurality of slice bodies can be processed in parallel.

The parallel-processing unit 140 receives the information on the slice headers from the header-parsing unit 130 and uses the received information for a task of decoding the slice bodies. The parallel-processing unit 140 dispatches decoding tasks for the plurality of slice bodies to multiple cores, by which the decoding tasks of the slice bodies can be processed in parallel.

When dispatching the decoding tasks to multiple cores, the parallel-processing unit 140 utilizes a task allocation unit and a task processing unit.

The task allocation unit dispatches the decoding tasks to multiple cores such that match to the number of cores shall be maintained. The task allocation unit matches the number of cores to the number of decoding tasks dispatched, so that the decoding tasks can be parallel processed by cores respectively.

The task processing unit dispatches the decoding tasks to multiple cores by thread so that a thread scheduling shall be used for the paralle processing. That is, the task processing unit dispatches the decoding tasks to the multiple cores by thread so that the decoding tasks can be processed in parallel by a thread scheduling.

The parallel-processing unit 140 transfers decoded data obtained by the tasks of decoding the slice bodies to a picture-configuration unit 150. The picture-configuration unit 150 arranges the decoded data of the plurality of slice bodies processed by the parallel-processing unit 140 to the respective blocks configuring a picture, with reference to a result of parsing the plurality of slice headers.

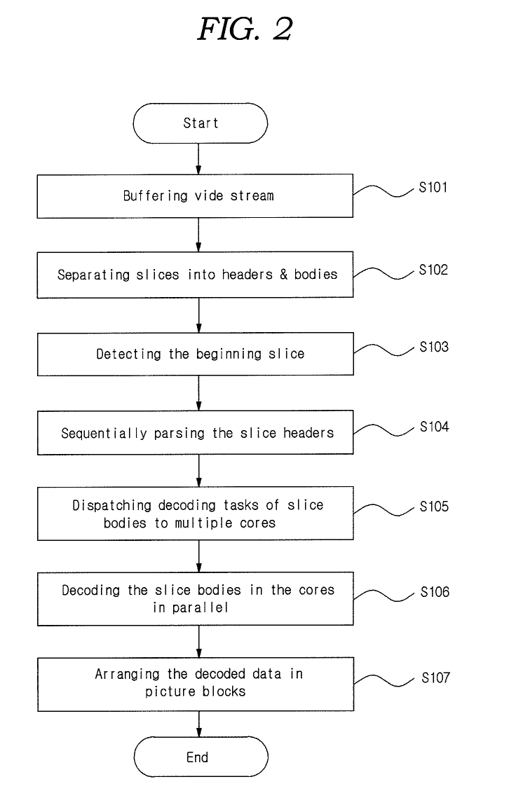

FIG. 2 is a flowchart illustrating a distributed decoding method of sequential parallel processing scheme according to the present invention. The multi-core processor is a processor provided with a plurality of cores and shows a high performance in a parallel processing of operation data. A process of decoding video stream using a sequential parallel processing scheme, performed by the multi-core processor that is advantageous in the parallel processing of operation data, will be described.

When a video file compressed by an H.264 codec and stored in a storage medium is opened by a user's handling or video stream encoded by an H.264 codec and transmitted online is received, the multi-core processor buffers the video stream containing a plurality of slices in a memory S101.

The multi-core processor separates the plurality of slices buffered in the memory into headers and bodies S102. The multi-core processor separates the respective slices into headers and bodies, where sequential parsing will be performed for headers and parallel decoding will be performed for bodies. The slice headers contain a compression method of video data and information on the location of the video data in a picture and are divided into a header that contains information on creating a frame for configuring the picture and a header that is not related to creating the frame of the picture. The slice bodies are video compression data compressed by the same compression algorithm, and are mutually independent.

The multi-core processor detects the beginning slice of a picture by sequentially parsing the plurality of separated slice headers S103. The beginning slice of a picture contains slice headers having information on creating a frame for configuring the picture.

If the beginning slice of a picture is detected among the plurality of slices, the multi-core processor sequentially parses the plurality of slice headers starting from the detected beginning slice S104. The multi-core processor obtains decoding information of the slice bodies corresponding to the plurality of slice headers by sequentially parsing the plurality of slice headers.

The multi-core processor dispatches decoding tasks of the plurality of slice bodies corresponding to the plurality of parsed slice headers S105. The multi-core processor assigns the multiple cores to the decoding tasks of the plurality of slice bodies, thereby causing the decoding tasks of the plurality of slice bodies to be parallel processed by the multiple cores.

The dispatching the decoding tasks may be established by the number of cores. Alternatively, the dispatching the decoding tasks may be established by thread. The multi-core processor assigns the decoding tasks to the multiple cores, so that the decoding tasks can be processed in parallel by the multiple cores.

The multiple cores perform the tasks of decoding the plurality of slice bodies in parallel, and output the decoded data S106. The multi-core processor arranges the plurality of decoded data processed in parallel by the multiple cores to respective blocks that configure a picture, with reference to a result of parsing the plurality of slice headers S107.

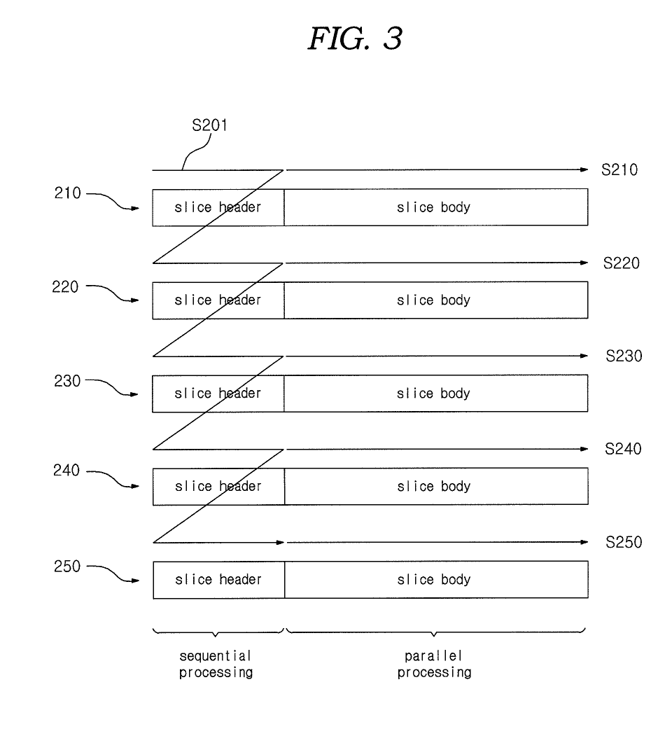

FIG. 3 is a view showing an example of decoding a plurality of slices according to the present invention. In an H.264 codec, video stream includes a plurality of slices 210 to 250. The slices are configured to have slice headers and slice bodies. The slice headers contain a compression method of video data and information on the location of the video data in a picture and are divided into a header that contains information on creating a frame for configuring the picture and a header that is unrelated to creating the frame of the picture. The slice bodies are video data compressed by the same compression algorithm, and are mutually independent.

The slice headers are sequentially parsed S201, by which header information is obtained to be utilized in decoding the slice bodies. The slice bodies are dispatched to multiple cores, and decoding tasks of the slice bodies are processed in parallel by the multiple cores S210-S250.

According to the present invention, there is an advantageous effect in that time for video decoding is reduced and high resolution video is smoothly processed by sequentially parsing slice headers and parallel decoding the slice bodies.

What is claimed is:

1. A distributed decoding device, comprising:
a memory for buffering video stream including a plurality of slices;
a detection unit for separating said plurality of slices into slice headers and slice bodies and for detecting a beginning slice of a picture based on information in said slice headers;
a header-parsing unit for sequentially parsing said slice headers beginning from said beginning slice so as to obtain header information for said picture;
a parallel-processing unit for receiving a plurality of slice bodies associated with said parsed slice headers, and for dispatching a plurality of tasks for decoding said slice bodies to multiple cores so that said multiple cores process said decoding tasks in parallel scheme; and
a picture-configuration unit for receiving header information from said header-parsing unit and receiving a plurality of decoded data from said parallel-processing unit wherein each of said decoded data corresponds to each of slice bodies, and for arranging said plurality of decoded data to picture blocks so as to configure said picture with referring to said header information.

2. The device as claimed in claim 1, wherein the parallel-processing unit dispatches said plurality of decoding tasks to multiple cores by thread so as to let said cores process said decoding tasks by thread scheduling.

3. A distributed decoding method, comprising:
buffering video stream including a plurality of slices;
separating said plurality of slices into slice headers and slice bodies;
detecting a beginning slice of a picture based on information in said slice headers;
sequentially parsing said slice headers beginning from said beginning slice so as to obtain header information for said picture;
dispatching to multiple cores a plurality of decoding tasks for said slice bodies which are associated with said parsed slice headers;
parallel processing said decoding tasks in said multiple cores; and
arranging, with referring to said header information, a plurality of decoded data to picture blocks so as to configure said picture.

4. The method as claimed in claim 3, wherein said plurality of decoding tasks are dispatched by thread to said multiple cores.
